(19) United States
(12) Patent Application Publication
(10) Pub. No.: US 2012/0082413 A1
(43) Pub. Date: Apr. 5, 2012

(54) AN OPTICAL CONNECTION SYSTEM

(75) Inventors: Kamal Alameh, Western Australia (AU); Yong Tak Lee, Gwangju (KR)

(73) Assignee: Edith Cowan University, Joondalup, Western Australia (AU)

(21) Appl. No.: 13/147,560

(22) PCT Filed: Feb. 4, 2010
(86) PCT No.: PCT/AU2010/000112

§ 371 Date: Nov. 21, 2011

(30) Foreign Application Priority Data
Feb. 5, 2009 (AU) 2009900429

(51) Int. Cl. G02B 6/43; G02B 6/42

(52) U.S. Cl. 385/24; 385/15; 385/27

(57) ABSTRACT

The present disclosure provides an optical connection system which comprises optical components that include a plurality of vertical cavity surface emitting lasers (VCSELs) for emitting modulated light in response to applied electrical signals and a plurality of receivers for receiving the emitted light. The optical components are arranged in at least two monolithically integrated modules each comprising at least two of the optical components. The optical connection system further comprises at least one light guiding component for guiding the light between the VCSELs and the receivers. The optical connection system also comprises coupling elements for coupling the at least one light guiding component to the monolithically integrated modules such that in use light is transmitted between modules via the at least one light guiding component.

### FIELD OF THE INVENTION

The present invention broadly relates to an optical connection system.

### BACKGROUND OF THE INVENTION

Modern computer systems include large numbers of CPUs and data storage devices which are distributed over a number of computer boards. Presently links between the computer boards are established using large numbers of conductive tracks or leads. However, electrical connections have fundamental physical limitations for high speed data transmission, which relate to electrical power requirements, transmission latency and achievable package density.

Data transmission between such computer boards may also be established using optical fibre links, which are coupled to optical transmitters and receivers. Such optical fibre links significantly increase the possible data transmission rate between the computer boards. However, alignment of the optical fibres relative to the optical transmitters is difficult and consequently assembly is cumbersome and expensive.

There is a need for technological advancement.

### SUMMARY OF THE INVENTION

The present invention provides in a first aspect an optical connection system comprising:

optical components comprising a plurality of vertical cavity surface emitting lasers (VCSELs) for emitting modulated light in response to applied electrical signals and a plurality of receivers for receiving the emitted light, the optical components being arranged in at least two monolithically integrated modules each comprising at least two of the optical components;

at least one light guiding component for guiding the light between the VCSELs and the receivers; and

coupling elements for coupling the at least one light guiding component to the monolithically integrated modules such that in use light is transmitted between modules via the at least one light guiding component.

In one specific embodiment the coupling elements may be perforated and may each comprise a processed silicon wafer. The coupling elements typically comprise bores and typically couple the modules to the at least one light guiding component such that light transmitted between the VCSELs and receivers is directed through the bores.

Each module typically is coupled to a respective coupling element. Alternatively, each module may be coupled to more than one coupling element. Further, each coupling element may be coupled to more than one module.

In one example each coupling element comprises electronic driver components for at least one VCSEL and/or at least one receiver of a module to which the coupling element is coupled. The coupling elements with electronic driver components may be provided in the form of monolithically integrated components.

Each coupling element may comprise at least two bores trough which in use light is directed. In one example each module comprises more than two optical elements and each module comprises a corresponding number of bores. Each coupling element typically comprises a number of bores through which in use light is directed and which corresponds to the number of optical elements of a module to which the coupling element is coupled.

In one example the at least one light guiding component comprises a plurality of optical fibres and each end of the optical fibres may be positioned in a respective bore of one of the coupling elements and arranged to transmit light between a respective VCSEL and a respective receiver.

The modules typically are coupled to the at least one light guiding component by the coupling elements so that in use the light travels a predetermined distance between a respective optical component and a respective end portion of an optical fibre.

Each VCSEL typically has a lens that may be formed on a surface of the VCSEL. In one embodiment each lens is arranged so that an emitted beam of light has a diameter of 100 μm or less, typically 50 μm or less or even 10 μm or less at a distance of 150 μm or 100 μm from a surface of the lens. In one specific example each lens is arranged so that the emitted beam of light has a diameter of less than 50 μm, such as 10 μm, at a distance of 100 μm of the surface of the lens. End-faces of the at least one light guiding component, such as a optical fibre or any other suitable optical light guide, having a suitable (core) diameter, such as 50 μm or even less, may be positioned within 100 μm of the surface of the lens in a manner such that at least the majority of the emitted light is received and subsequently guided by the at least one light guiding component.

The plurality of VCSELs typically comprises first and second VCSELs and the plurality of receivers typically comprises first and second receivers. At least one first VCSEL and at least one second receiver may form a first monolithically integrated module. At least one second VCSEL and at least one first receiver may form a second monolithically integrated module. The first and second monolithically integrated modules typically are arranged and positioned so that in use the at least one first receiver receives light from a respective first VCSEL and the at least one second receiver receives light from a respective second VCSEL.

In one specific embodiment the modules are coupled to the coupling elements by flip-chip bonding. Flip-chip bonding has the significant advantage that it is possible to position each coupling element accurately at a predetermined position relative to a respective module, for example with a lateral accuracy of the order of ±10 μm and a distance accuracy of the order of 5 μm.

Each bore of the coupling elements may have a first and a second bore portion. Each first bore portion has a smaller diameter than each second bore portion. The first bore portions may be oriented towards the modules and the second bore portions may be arranged to receive ends of light guides. Each first bore portion typically has a diameter that is smaller than a diameter of the light guiding component, such as end of optical fibres. The coupling elements and the modules typically are arranged so that, when the ends of the light guides have penetrated into respective second bore portions and the coupling elements are coupled to the modules, the ends of the optical light guides are positioned at predetermined positions for receiving light form the VCSELs or directing light to the receivers.

In one specific example the first bore portions have a diameter of the order 50 μm and the second bore portions have a diameter larger than approximately 125 μm, such as 130 μm, so that ends of optical fibres having a cladding diameter of 125 μm may be received by the second bore portions. The bores may be formed by reactive ion etching and each coupling element may be formed from a silicon wafer, such as a silicon wafer having a thickness of the order of 300 μm. Metallic contacts may be deposited onto the coupling elements and corresponding metallic contacts may be deposited onto the modules. The metallic contacts of the modules are then joined with the respective metallic contacts of the coupling elements in the flip-chip bonding process.

For example, each VCSEL with a respective lens may be arranged so that an emitted beam of light has a diameter of less than 50 μm, or even less than 10 μm, at a distance of 100 μm from a respective lens. The end-faces of the optical fibres (or any other suitable light guide) may be positioned with an accuracy of ±50 μm or less and the optical connection system typically is arranged so that positioning of each the end-faces of the optical fibres within 100 μm from the respective lens is possible. As described above, the positioning tolerance of the coupling elements relative to the modules typically is sufficiently low so that the end-faces of the optical fibres can be positioned accurately within an optimal working distances of the VCSELs with lenses in a relatively uncomplicated manner.

The coupling elements have significant practical advantages. It is possible to position and locate the light guides, such as optical fibres, relative to the VCSELs and receivers in a relatively simple and accurate manner that facilitates large scale production. Difficult alignment of optical light guides relative to the VCSELs or receivers can be avoided. Further, there is typically no need for additional fibre holders or ferrules.

The optical connection system may be arranged for establishing data transmission between electronic boards. Alternatively, the optical connection system may be arranged for chip-to-chip communication.

Each receiver component typically is a resonance cavity enhanced photo detector (RCE-PD).

The monolithically integrated modules may comprise arrays of VCSELs and receivers. For example a first module may comprise an array of VCSELs but no receivers and a second array may comprise receivers but no VCSELs. Each array may also comprise VCSELs and receivers that may be positioned adjacent each other in an alternating fashion.

The VCSELs and the RCE-PDs typically have a number of components that are substantially identical. For example, the VCSEL and the RCE-PDs may comprise substantially the same layered structure that forms one of the reflectors of each cavity of the VCSELs and the RCE-PDs. In one specific embodiment of the present invention 10, 20, 40 or even 50% of the processing steps used for fabrication of each VCSEL are identical with processing steps used for fabrication of each RCE-PD and typically conducted in conjunction, which facilitates fabrication of the monolithically integrated modules.

The present invention provides in a second aspect an optical connection system comprising:

a plurality of optical components including vertical cavity surface emitting lasers (VCSELs) for emitting modulated light in response to applied electrical signals and receivers for receiving the emitted light, the receivers being arranged for converting the received light into electrical signals;

wherein the optical components are arranged in at least two monolithically integrated modules each comprising at least two of the optical components, and wherein the VCSELs and receivers are positioned for transmission of the modulated light between the at least two monolithically integrated modules through respective spaces that are defined between the VCSELs and the receivers.

For example, the spaces that may be defined between the VCSELs and respective receivers may largely be spaces in a fluid, such as a suitable liquid or air. The optical connection system may be arranged so that transmission of data in the form of modulated light is possible through the spaces without optical fibres, optical cables or any other type of optical light guide. Further, an optically transmissive medium may be positioned between the VCSELs and respective receivers. The optically transmissive medium may have a largely uniform refractive index and may for example be provided in the form of a polymeric material or glass.

The optical connection system may be arranged so that the light is directed through the spaces along a distance of more than 5, 10, 15 20, 25 20, 30 50 mm or any other distance.

Each VCSEL typically has a lens that may be formed on a surface of the VCSEL and may be integrally formed with the VCSEL. In one specific example each lens is arranged to expand an emitted beam of light behind a focal region to a relatively large diameter at a position relatively close to a respective VCSEL. Because of the relatively large diameter of beam of light the after expansion, problems associated with divergence of a beam light having a diameter of a few μm can be avoided. It will be appreciated that in a further variation a suitable diverging lens may also be used to achieve a similar expansion of the beam of emitted light at a position close to the diverging lens.

In one embodiment at least two further lenses may be positioned between respective VCSEL and receivers. A first lens typically is arranged to receive light emitted from a respective VCSEL and typically is arranged to substantially collimate the received light. A second lens typically is arranged to receive the substantially collimated light from the first lens and focus the light onto a receiving surface of a respective receiver component. The first and second lenses may be separated by a distance of more than 10, 20, 30, 40 or even 50 mm. The lenses typically are ordered in arrays.

The present invention provides in a third aspect a method of forming an optical connection system, the method comprising:

providing a module including at least one vertical cavity surface emitting laser (VCSEL) for emitting modulated light in response to an applied electrical signal;

providing an optical light guide;

providing a coupling element for coupling the at least one optical light guide, the coupling element having a recess for receiving a predetermined length of an end-portion of the optical light guide;

attaching the optical light guide to the recess of the coupling element so that the optical light guide is held at a predetermined position relative to a surface of the coupling element; and attaching the surface of the coupling element to a surface of the module using a flip-chip bonding process so that the end-portion of the optical light guide is positioned at a predetermined position relative to the VCSEL for receiving light from the VCSEL.

The present invention provides in a fourth aspect an optical connection system comprising:

optical components comprising a plurality of vertical cavity surface emitting lasers (VCSELs) for emitting modulated light in response to applied electrical signals and a plurality of receivers for receiving the emitted light, each VCSEL having a lens formed on a surface of the VCSEL, the optical components being arranged in at least two monolithically integrated modules each comprising at least two of the optical components;

at least one light guiding component for guiding the light between the VCSELs and the receivers; and

coupling elements for coupling the at least one light guiding component to the monolithically integrated modules such that in use light is transmitted between modules via the at least one light guiding component, the coupling element comprising bores, each bore having a first and a second bore portion and the first bore portions have a smaller diameter than the second bore portions, the first bore portions being oriented towards the modules and the second bore portions being arranged to receive ends of the light guiding component and the coupling elements being coupled to the modules by flip-chip bonding.

The present invention provides in a fifth aspect an optical connection system comprising:

optical components comprising a plurality of vertical cavity surface emitting lasers (VCSELs) for emitting modulated light in response to applied electrical signals and a plurality of receivers for receiving the emitted light, the optical components being arranged in at least two monolithically integrated modules each comprising at least two of the optical components;

at least one light guiding component for guiding the light between the VCSELs and the receivers; and

coupling elements for coupling the at least one light guiding component to the monolithically integrated modules such that in use light is transmitted between modules via the at least one light guiding component, each coupling element comprising bores, each bore having a first and a second bore portion and the first bore portions have a smaller diameter than the second bore portions, the first bore portions being oriented towards the modules and the second bore portions being arranged to receive ends of the light guiding component, each coupling element comprising a processed silicon wafer and the processed silicon wafer comprising the bores through which light that is transmitted between the VCSELs and receivers.

The present invention provides in a sixth aspect a method of forming an optical connection system, the method comprising:

providing a module including at least one vertical cavity surface emitting laser (VCSEL) for emitting modulated light in response to an applied electrical signal, each VCSEL having a lens formed on a surface of the VCSEL;

providing an optical light guide;

providing a coupling element for coupling the at least one optical light guide light to the module such that in use light is transmitted via the optical light guide, the coupling element may comprise a processed silicon wafer that comprises bores through which the light transmitted; the bore having a first and a second bore portion and the first bore portion have a smaller diameter than the second bore portion, the first bore portion being oriented towards the module and the second bore portion being arranged to receive an end of the optical light guide;

attaching the optical light guide to the coupling element so that the end of the optical light guide is held at a predetermined position relative to a surface of the coupling element in the bore; and

attaching the surface of the coupling element to a surface of the module using a flip-chip bonding process so that the end-portion of the optical light guide is positioned at a predetermined position relative to the VCSEL for receiving light from the VCSEL.

The invention will be more fully understood from the following description of specific embodiments of the invention. The description is provided with reference to the accompanying drawings.

### BRIEF DESCRIPTION OF THE DRAWINGS

FIG. 1 shows an optical connection system according to an embodiment of the of the present invention;

FIG. 2 shows a component of an optical connection system according to an embodiment of the present invention; and

FIGS. 3 and 4 illustrate an optical connection system according to a further embodiment of the present invention.

### DETAILED DESCRIPTION OF SPECIFIC EMBODIMENTS

The present invention broadly relates to an optical connection system. The optical connection system comprises a plurality of optical components including vertical cavity surface emitting lasers (VCSELs) for emitting modulated light in response to applied electrical signals and receivers for receiving the emitted light. The receivers are arranged for converting light received from respective VCSELs into electrical signals.

The optical components are arranged in at least two monolithically integrated modules with each integrated module comprising at least two of the optical components. The VCSELs and receivers are arranged so as to allow transmission of modulated light between the monolithically integrated modules.

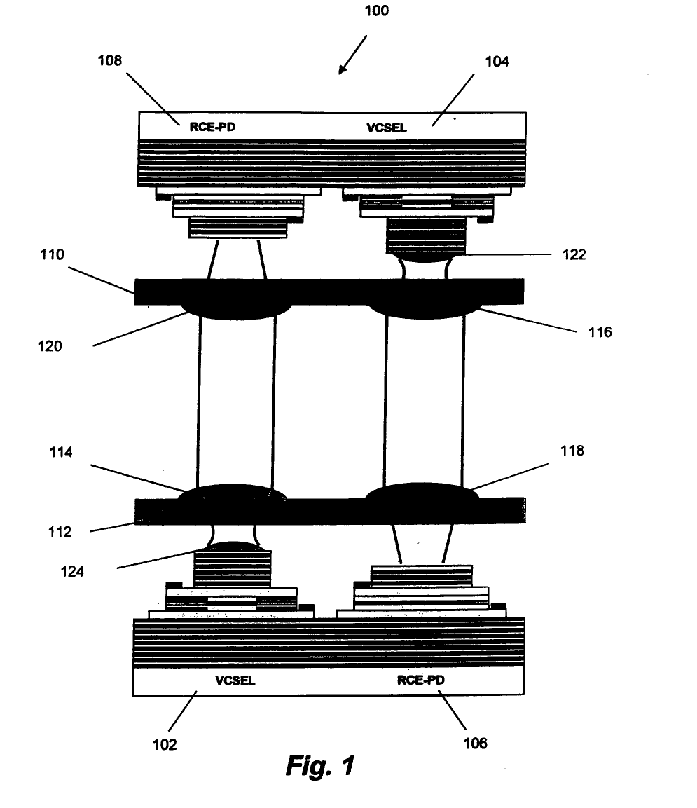

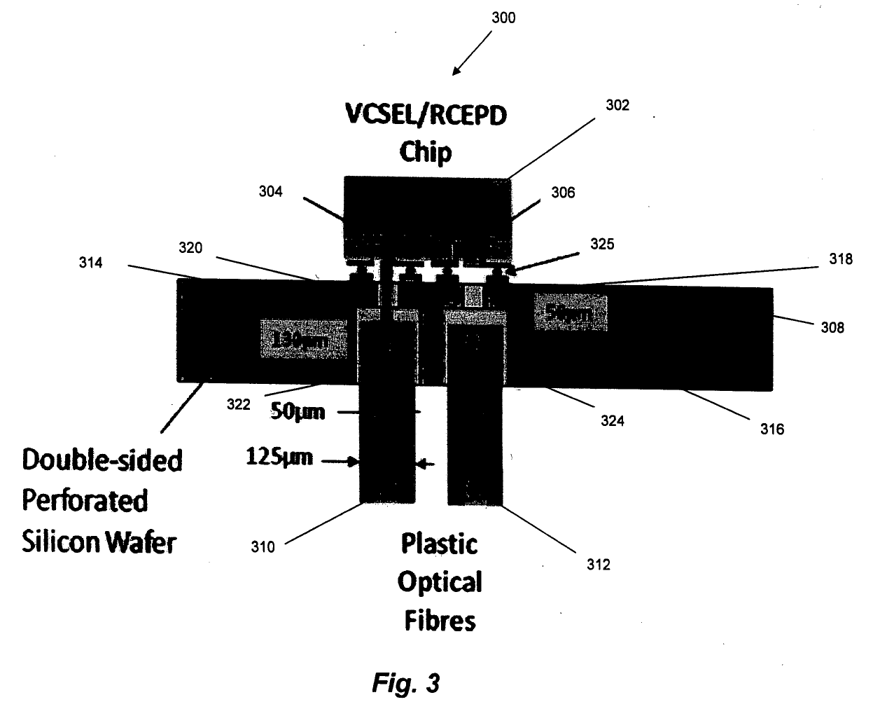

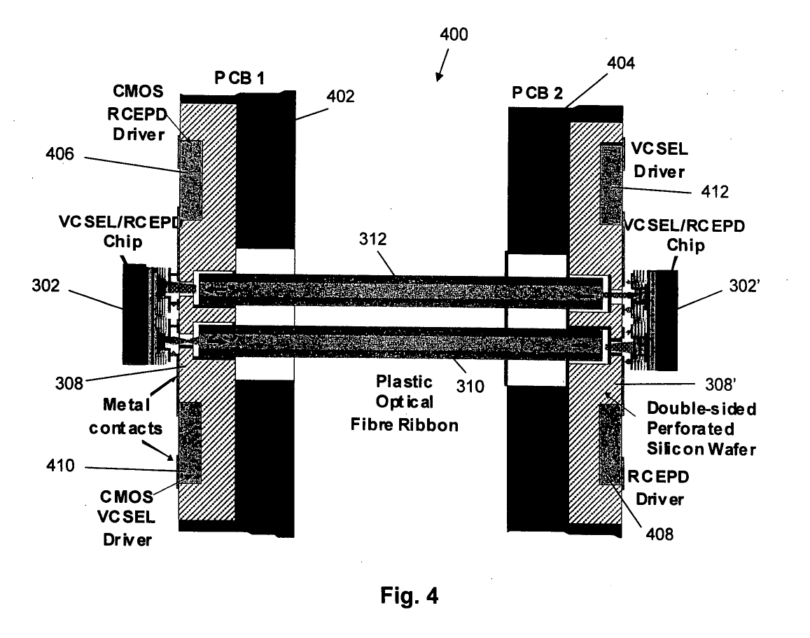

The transmission of modulated light between the monolithically integrated modules may be facilitated in various ways, such as by coupling a light guide between the integrated modules. Such an example is described later and with reference to FIGS. 3 and 4. In another example, the transmission of modulated lights between the integrated modules may be conducted through air and is facilitated by positioning respective VCSEL and receiver pairs opposite one another and arranging a lens system there between. This example will be described initially and with reference to FIG. 1.

Referring initially to FIG. 1, an optical connection system according to a specific embodiment of the present invention is now described. The optical connection system 100 comprises vertical cavity surface emitting lasers (VCSELs) 102 and 104. Further, the system 100 comprises optical receivers, which in this embodiment are provided in the form of resonance cavity enhanced photo-detectors (RCE-PDs) 106 and 108. The VCSELs 102 and 104 are arranged to emit modulated beams of light in response to an applied electrical signals. The system 100 also comprises lenses 114, 116, 118 and 120, which are held by holders 110 and 112 and which are positioned between the VCSELs and the RCE-PDs.

In this embodiment the optical connection system 100 is arranged so that data can be transmitted via the modulated beams of light through spaces between the lens 114, 116, 118 and 120 and typically though air or another suitable fluid including a suitable liquid. For example, the VCSEL 102 and the RCE-PD 106 may be positioned on a first electronic board, such as a computer board, and the VCSEL 104 and the RCE-PD 108 may be positioned on a second electronic board. If the electronic boards are aligned relative to each other, for example using suitable slots that hold the boards in predetermined positions, data transmission between the boards is possible without optical fibres or electrical connections for transmitting the data. Embodiments of the present invention consequently combine the advantageous speed of optical connections with simplicity of assembly and flexibility of application.

However, it will be appreciated that the light may not necessarily be transmitted through spaces and may alternatively be transmitted using optical light guides, which will be described later with reference to FIGS. 3 and 4.

The lenses 116 and 114 are arranged to collimate light that is received from the VCSELs 102 and 104. The VCSELs also comprise lenses 122 and 124. The lenses 122 and 124 are integrated with the VCSELs 104 and 102, respectively, and are formed on portions of the VCSELs. In this embodiment the lenses 122 and 124 have converging properties.

The lenses 122 and 124, which are integrated with the VCSELs 102 and 104, provide the advantage that the emitted beams of light are expanded to a beam diameter of approximately 100-140 micrometers at a position relatively close to the VCSELs. If the VCSELs 102 and 104 would not have the lenses 122 and 124, the emitted beams of light would also expand, but expansion to 100-140 micrometer beam diameter would only happen at a distance much further from the VCSELs. Consequently, the lenses 122 and 124 provide the advantage that the lenses 114 and can be positioned relatively close to the VCSEL components 102 and 104.

A person skilled in the art will appreciate that in alternative embodiments the lenses 122 and 124 may not necessary be arranged for converging light, but may also be light diverging lenses.

Further, it is to be appreciated by a person skilled in the art that alternatively the optical system 100 may be arranged to transmit the modulated light through an optically transmissive material that is positioned between the VCSELs and respective receivers. The optically transmissive material may have a largely uniform refractive index and may for example be provided in the form of a polymeric material or glass. The optically transmissive material may also be arranged to support the lenses 114, 116, 118 and 120. Further, the lenses 114, 116, 118 and 120 may be integrated with the optically transmissive material.

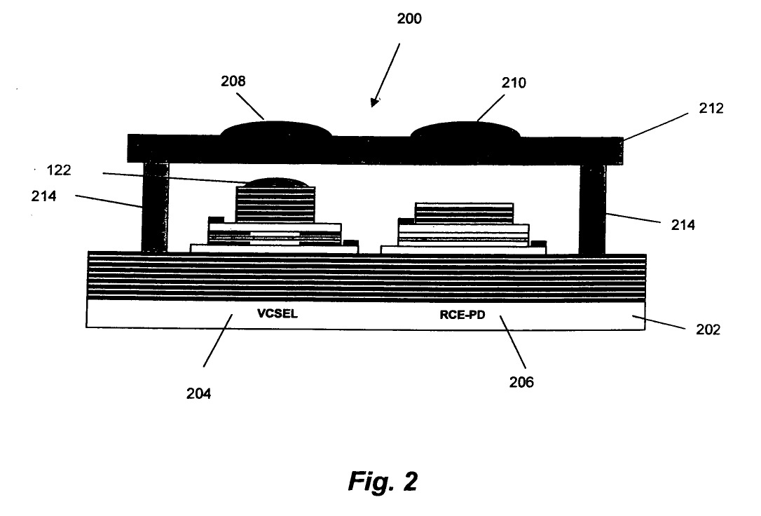

Referring now to FIG. 2, components of the optical connection system according to embodiments of the present invention are now described in further detail. FIG. 2 shows a component 200 that comprises a substrate 202 on which a VCSEL 204 and a RCE-PD 206 are positioned. Further, lenses 208 and 210 are positioned over the VCSEL 204 and RCE-PD 206. The lenses 208 and 210 are positioned in a holder 212 which is supported by spacers 214. The spacers 214 have a length of approximately 300 μm.

The VCSEL 204 comprises an integrated lens 216 which is positioned very close to the lens 208.

The VCSEL 204 and RCE-PD 206 are integrated components. In this embodiment the VCSEL 204 and RCE-PD 206 both comprise first mirrors which are formed from the same layered structure 218. The VCSEL 204 and RCE-PD 206 are manufactured using etching and film-deposition techniques that are known in semiconductor industry. The VCSEL 204 and RCE-PD 206 include structural differences that can be achieved using dedicated etching and film deposition techniques.

The person skilled in the art will appreciate that the substrate 202 may support any numbers of VCSELs and/or RCE-PDs, such as arrays of VCSELs and/or RCE-PDs. Further, a person skilled in the art will appreciate that the holder 212 may support any number of lenses 208 and 210 which may also be arranged in an array. The holders 110 and 112 shown in FIG. 1 may be arranged in the same manner as the holder 212 shown in FIG. 2.

The fabrication of the lens 122, 124 and 216 positioned on the top-face of the VCSEL components 102, 104 and 204 is now described. A digital alloy of AlₓGa₁₋ₓAs is formed on the layered structure (the “bottom layered structure”) associated with the VCSEL. The digital alloy comprises a further layered structure (the “top layered structure”) including AlAs and GaAs thin layers having layer thickness ranging from 2-90 monolayers. The AlAs and GaAs layers are deposited using molecular beam epitaxy (MBE) or metal organic chemical vapour deposition (MOCVD). The top layered structure is capped with a GaAs layer having a thickness of approximately 100 nm. Conventional etching techniques are used to shape the two-dimensional extension of the top layered structure and one etching procedure may be used to shape the top layered structure and the bottom layered structure together. The top layered structure is then annealed in oxygen environment so that some of the aluminium contained in the AlAs layers of the AlAs/GaAs digital alloy oxidises. The GaAs capping layer acts as a vertical oxygen diffusion barrier and more aluminium in the AlAs oxidises at exposed side-portions of the etched top layered structure. Properties (e.g. layer thicknesses) of the top-layered structure are chosen so that a convexly shaped region comprising non-oxidised aluminium in formed on the top-face of the VCSEL. The oxidation outside that region reduces the refractive index of the digital alloy and consequently the convexly shaped region has the focusing function of a lens for light that is emitted by the VCSEL. The oxidised aluminium over the convexly-shaped region and the GaAs capping layer may be removed using suitable etching procedures so that the lens having a substantially spherical outer surface is formed. In a variation of the described embodiment, the properties of the top-layered structure, in particular the relative thicknesses of the AlAs and AlAs/GaAs layers, may also be chosen so that the lens has diverging properties. For example, the properties may be chosen so that the formed lens has, in a cross-section that includes an axis of the lens, two concavely curved boundaries that extend from an apex to the top-face of the VCSEL. Further, a lens fabrication method in which AlAs is selectively etched may be used instead of the described selective oxidation method. Further details on the lens fabrication are described in Korean patent application nos. 102005114145 and 1020040091224, which are herein incorporated by cross-reference.

FIG. 3 shows an optical connection system 300 according to a further embodiment of the present invention. The optical connection system 300 comprises a chip 304 including monolithically integrated VCSELs and RCE-PDs. The VCSELs and RCE-PDs are analogous to those of the optical connection systems 100 and 200 illustrated above. Each VCSEL includes a lens 122 or 124 and is positioned adjacent a RCE-PD. However, in this case each lens 122 is not arranged to expand the beam of light to a relatively large diameter, but is arranged so that an emitted beam of light has a diameter of less than 50 μm or even less than 10 μm at a distance of approximately 100 μm from the lens.

The chip 302 may comprise any number of VCSELs 304 and receivers 306. The monolithically integrated structures take advantage of the similarities between the VCSELs and the RCE-PDs. Many layers of the VCSELs and the RCE-PDs are identical and it is therefore possible to produce chips having VCSELs adjacent to RCE-PDs in a cost efficient manner.

The optical connection system 300 also comprises a coupling element 308 for coupling with optical fiber portions 310 and 312. The coupling element 308 is formed from a silicon wafer having a thickness of 300 μm. The coupling element 308 has a first side 314 and a second side 316. For fabrication of the coupling element 308, bores 318 and 320 are formed in the coupling element 308. The bores 318 and 320 have a thickness of the order of 50 μm. Further bores 322, 324 are formed from the second side 316 of the coupling element 308. The further bores 322 and 324 are coaxial with the bores 320 and 318, respectively, and have a thickness of the order of 130 μm. The bores 322 and 324 have a thickness sufficient to receive ends of the optical fibers 310 and 312 which are inserted into bores 322 and 324, respectively, and attached using a suitable adhesive. In this embodiment the optical fibers comprise a core and cladding region and are formed from a plastics material. It will be appreciated, however, that alternatively the walls may have differing dimensions and may be arranged to receive any other type of optical fibers. For example, the bores 318, 320, 322 and 324 may be formed using reactive ion etching or using any other suitable method.

In this embodiment the optical connection system 300 does not comprise any lenses spaced from the VCSELs 304 and RCE-PDs 306. Light that is generated by the VCSEL 304 is focused by the lens 122 and then directly received by an end of a respective optical fiber such as optical fibre 310. The chip 302 and the coupling element 308 are coupled by flip-chip bonding. For this bonding process solder bumps are positioned on the first surface 314 of the coupling element 308 and/or on the bottom surface of the chip 302 onto metallic surface portions, such as surface portions that are coated with a copper. The chip 302 and the coupling element 308 are then carefully positioned relative to each other to a predetermined relative position at which the solder bumps are enabled to connect the chip 302 with the coupling element 308. This connection process may, for example, comprise local heating and melting of the solder material of the solder bumps so that the solar material connects respective surface portions of the chip 302 and the coupling element 308.

It is possible to align the chip 302 on the coupling element 308 with a distance accuracy of approximately 5 μm and a lateral accuracy of approximately 10 μm using the flip-chip bonding technique. The positioning tolerance of the end-faces of the optical fibers relative to the VCSEL 304 typically is 50 μm. The bores of the coupling element 308 are arranged, and module 302 is sufficiently close to the coupling element 308, so that it is possible to position the end-faces of m of each lens 122 of the VCSEL 304 and the optical fibers within 100 consequently the end-faces receive at least the majority of the light emitted by the VCSELs 304.

Consequently, the coupling element 308 and the flip-chip bonding technique together offer the significant advantage that is it relatively uncomplicated to position the ends of the optical fibers relative to the VCSELs in a predetermined and well defined manner.

FIG. 4 shows an optical connection 400. The optical connection system 400 comprises components of the optical connection system 300. The optical connection system 400 comprises first and second chips 302, 302′, first and second coupling elements 308, 308′ and optical fibers 310 and 312, but in a variation of this embodiment may also comprise any other optical light guiding medium that replaces the optical fibers. The chips 302, 302′ are arranged so that light emitted by a VCSEL 304 of one of the chips 302, 302′ is received by an RCE-PD of the other chip 302′, 302.

Each coupling element 308, 308′ may comprise a CMOS VCSEL driver and a CMOS RCE-PD driver for driving a respective VCSEL 304 and RCE-PD 306 of each chip 302, 302′. In this way, each coupling element 308, 308′ comprises both means for coupling the chip 302, 302′ to the optical fibers 310, 312 and means for driving the VCSEL 304 and RCE-PD 306 of the chip 302.

In the example shown in FIG. 4, a first coupling element 308 comprises a CMOS RCE-PD driver 406 and a CMOS VCSEL driver 410 and a second coupling element 308′ comprises a CMOS RCE-PD driver 408 and a CMOS VCSEL driver 412. The coupling elements 308, 308′ are positioned on PC boards 402 and 404 respectively.

It will be appreciated that the PC boards 402 and 404 may be positioned at any suitable position relative to each other and the optical fibers 310 and 312 may be bent and located to enable the connection between the boards 402 and 404. Further, it will be appreciated that in the same manner any number of optical connections between computer boards may be established.

Further, each optical connection system 100, 300 or 400 may comprise arrays of any number of RCE-PDs or VCSELs. For example, a first array of 10, 50, 100, 1000 or any other number of VCSEL components or RCE-PDs may be opposed by a second array having the same number of VCSELs and RCE-PDs and the arrays may be arranged so that each VCSEL opposes a respective RCE-PD. In one example each VCSEL is positioned next to a RCE-PD. In variations of this example, groups of VCSELs may be positioned next to groups of RCE-PDs. Further, for one-way communication, a first array may only comprise VCSELs and a second array may only comprise RCE-PDs. Two or more arrays of the VCSELs or the RCE-PDs may also be positioned adjacent each other and may oppose the same number of arrays of the RCE-PDs and the VCSELs.

The reference that is being made to Korean patent application numbers 102005114145 and 1020040091224 does not constitute an admission that the disclosure of these Korean patent applications is a part of the common general knowledge in Australia or any other country.

Although the invention has been described with reference to particular examples, it will be appreciated by those skilled in the art that the invention may be embodied in many other forms.

1. An optical connection system comprising:
optical components comprising a plurality of vertical cavity surface emitting lasers (VCSELs) for emitting modulated light in response to applied electrical signals and a plurality of receivers for receiving the emitted light, the optical components being arranged in at least two monolithically integrated modules each comprising at least two of the optical components;
at least one light guiding component for guiding the light between the VCSELs and the receivers; and
coupling elements for coupling the at least one light guiding component to the monolithically integrated modules such that in use light is transmitted between modules via the at least one light guiding component.

2. The optical connection system of claim 1 wherein the coupling elements comprise bores, the coupling elements being arranged to couple the modules to the at least one light guiding component such that light transmitted between the VCSELs and receivers is directed through the bores.

3. The optical connection system of claim 2 wherein each bore of the coupling elements has a first and a second bore portion and the first bore portions have a smaller diameter than the second bore portion and wherein the first bore portions are oriented towards the modules and the second bore portions are arranged to receive ends of the light guiding component.

4. The optical connection system of claim 3 wherein the first bore portions have a diameter of the order 50 μm and the second bore portions have a diameter larger than approximately 125 μm.

5. The optical connection system of claim 3 or 4 wherein each first bore portion has a diameter that is smaller than a diameter of the light guides.

6. The optical connection system of any one of claims claims 3 to 5 wherein the coupling elements and the modules are arranged so that, when the ends of the light guides have penetrated into respective second bore portions and the coupling elements are coupled to the modules, the ends of the light guides are positioned at predetermined positions for receiving light form the VCSELs or directing light to the receivers.

6. The optical connection component of any one of the preceding claims wherein the coupling elements comprise processed silicon wafers.

7. The optical connection system of any one of the preceding claims wherein each module is coupled to a respective coupling element.

8. The optical connection component of any one of claims 1-6 wherein each module is coupled to more than 1 coupling element.

9. The optical connection component of any one of the preceding claims wherein each coupling element comprises electronic driver components for at least one VCSEL and/or at least one receiver of a module to which the coupling element is coupled.

10. The optical connection component of claim 9 wherein the coupling elements with electronic driver components are provided in the form of monolithically integrated components.

11. The optical connection system of any one of the preceding claims wherein each coupling element comprises at least two bores trough which in use light is directed.

12. The optical connection system of claim 7 wherein each coupling element comprises a number of bores through which in use light is directed and which corresponds to the number of optical elements of the module to which the coupling element is coupled.

13. The optical connection system of any one of the preceding claims wherein the at least one light guiding component comprises a plurality of optical fibres and each end of the optical fibres is positioned in or adjacent a respective bore of one of the coupling elements and arranged to transmit light between a respective VCSEL and a respective receiver.

14. The optical connection system of claim 13 wherein the modules are coupled to the at least one light guiding component by the coupling elements so that in use the light travels a predetermined distance between a optical component and a respective end portion of an optical fibre.

15. The optical connection system of any one of the preceding claims wherein each VCSEL has a lens that is formed on a surface of the VCSEL.

16. The optical connection system of claim 15 wherein each lens is arranged so that an emitted beam of light has a diameter of 50 μm or less at a distance of 100 μm from a surface of the lens.

17. The optical connection system of any one of the preceding claims wherein the modules are coupled to the coupling elements by flip-chip bonding.

18. The optical connection component of any one of the preceding claims wherein the optical connection system is arranged for establishing data transmission between electronic boards.

19. The optical connection component of any one of claims 1-17 wherein the optical connection system is arranged for chip-to-chip communication.

20. The optical connection system of any one of the preceding claims wherein each receiver component is a resonance cavity enhanced photo detector (RCE-PD).

21. The optical connection system of any one of the preceding claims wherein each monolithically integrated module comprise an array of VCSELs and receivers.

22. The optical connection system of claim 21 wherein each array comprises VCSELs and receivers that are positioned adjacent each other in an alternating fashion.

23. An optical connection system comprising:
a plurality of optical components including vertical cavity surface emitting lasers (VCSELs) for emitting modulated light in response to applied electrical signals and receivers for receiving the emitted light, the receivers being arranged for converting the received light into electrical signals;
wherein the optical components are arranged in at least two monolithically integrated modules each comprising at least two of the optical components, and wherein the VCSELs and receivers are positioned for transmission of the modulated light between the at least two monolithically integrated modules through respective spaces that are defined between the VCSELs and the receivers.

24. The optical connection component of claim 23 wherein the spaces that are defined between the VCSELs and respective receivers are largely spaces in air.

25. The optical connection system of claim 23 or 24 wherein each VCSEL has a lens that is integrally formed with the VCSEL and that is arranged to expand an emitted beam of light behind a focal region to a relatively large diameter at a position relatively close to a respective VCSEL.

26. The optical connection component of claim 25 comprising at least two further lenses positioned between respective VCSEL and receivers; a first lens being arranged to receive light emitted from a respective VCSEL and arranged to substantially collimate the received light and a second lens being arranged to receive the substantially collimated light from the first lens and focus the light onto a receiving surface of a respective receiver component.

27. A method of forming an optical connection system, the method comprising:
providing a module including at least one vertical cavity surface emitting laser (VCSEL) for emitting modulated light in response to an applied electrical signal;
providing an optical light guide;
providing a coupling element for coupling the at least one optical light guide, the coupling element having a recess for receiving a predetermined length of an end-portion of the optical light guide;
attaching the optical light guide to the recess of the coupling element so that the optical light guide is held at a predetermined position relative to a surface of the coupling element; and
attaching the surface of the coupling element to a surface of the module using a flip-chip bonding process so that the end-portion of the optical light guide is positioned at a predetermined position relative to the VCSEL for receiving light from the VCSEL.
